(19) United States
(12) Patent Application Publication
(10) Pub. No.: US 2025/0078186 A1
(43) Pub. Date: Mar. 6, 2025

(54) Systems and Methods for Integrated Purchasing of New Construction and Related Requirements

(71) Applicants: Jason Matthew LEWKOWICZ, Bloomfield Hills, MI (US); Brandon Keith JONES, Marietta, GA (US); Stephanie Leigh BYRON, Roswell, GA (US)

(72) Inventors: Jason Matthew LEWKOWICZ, Bloomfield Hills, MI (US); Brandon Keith JONES, Marietta, GA (US); Stephanie Leigh BYRON, Roswell, GA (US)

(21) Appl. No.: 18/073,187

(22) Filed: Dec. 1, 2022

Related U.S. Application Data
(60) Provisional application No. 63/284,911, filed on Dec. 1, 2021.

(51) Int. Cl. G06Q 50/16

(52) U.S. Cl. CPC G06Q 50/167

(57) ABSTRACT

A plurality of on-line and app-based systems and methods for purchasing new construction are provided, including, though not limited to, systems and methods for the integrated purchasing of new homes and related requirements such as home sites, elevations, interior designs, purchase contracts, and earnest money deposits.

### CROSS-REFERENCE TO RELATED APPLICATIONS

The present application claims benefit of U.S. Provisional Application No. 63/284,911, filed Dec. 1, 2021, which claims benefit of U.S. Provisional Application No. 63/419,534, filed Oct. 26, 2022, the entire contents of which is incorporated herein by reference.

### FIELD OF THE INVENTION

The present invention relates generally to on-line and app-based purchasing of new construction, and in a particular though non-limiting embodiment to systems and methods for the integrated purchasing of new homes and related requirements such as home sites, elevations, interior designs, purchase contracts, and earnest money deposits.

### BACKGROUND

Historically, the new home purchasing process has been handled in a serial manner, typically beginning with an interview between a buyer (and perhaps their agent) and a sales representative of a builder or community developer.

For new homes, after discussing price ranges and different elevations, etc., the builder or community developer representative will usually take prospective buyers out to various lots in-line with the representative's understanding of the buyer's purchasing profile. If the buyer failed to adequately communicate expectations or if the representative misunderstood the buyer's needs, however, it is quite possible that a sale agreement will not be realized even when such was available within the expectations of the buyer.

Other shortcomings of the arrangement include a lack of candor on the part of buyer, some of whom are uncomfortable sharing financial and credit information with the representative, or even their spouse or agent. In addition, when buyers are looking at lots, it may be difficult for the buyer to envision various elevations and interior designs, etc.

Unfortunately, for the builder representative some buyers are merely shopping for ideas regarding where they may want to live, third-party design inspirations, etc. In such circumstances, it is very rare an apparent buyer will actually sign a contract and put down the earnest money necessary to hold the house, lot and related particulars. Consequently, the builder or community development representatives waste time, money and effort pursuing sales opportunities that fail to materialize.

For their part, the buyers are frequently frustrated and confused by a lack of transparency in the process and/or a plurality of other entry barriers that prevent or inhibit consummation of an agreement.

Moreover, either (or both) parties' interest in reaching agreement are often frustrated by factors beyond their control, such as the recent pandemic or even persistent bad weather. Furthermore, certain prospective buyers are intimidated by the process, and much like automobile purchasers wind up leaving without placing an order because they feel pressured or confused, or worse, actually do purchase but later have remorse because they regret their purchasing decision and/or attempt to back out of their agreement.

There is, therefore, a long-felt but unmet need for integrated, transparent, informative methods and systems that empower buyers while reducing entry barriers and encouraging completion of the purchasing process in a fast, efficient and secure environment, wherein buyers achieve a satisfactory purchasing arrangement and builder representatives waste less time, money and effort structuring an agreement that satisfies both sides.

### DETAILED DESCRIPTION OF SEVERAL REPRESENTATIVE EMBODIMENTS

Suitable methods and systems for achieving the objects of the invention are presented for illustrative purposes only. The instant disclosure is not intended to capture every aspect of the invention, and ordinarily skilled artisans will readily appreciate that all steps, functions, processes and subsystems may be added to, subtracted from, modified and/or performed or enabled in different orders, combinations, and efficiencies than the illustrative embodiments disclosed herein.

In one example embodiment, the process starts with a prospective buyer accessing a web site, portal, app or other integrable medium either now known or future devised. For example, in an instance where a buyer reaches the builder or developer website via the internet, a plurality of access options is provided. In one example embodiment, access to the builder or developer website is reached via a direct link on the builder website.

In another example embodiment, access is achieved through a link embedded in the community or development website, and in still other embodiments access is achieved by clicking through to the purchase site using links otherwise found on the internet.

In some embodiments, regardless of the source of the referring link, all access options are tied-in to a single referring URL scheme in communication with which the instant system is disposed. In other embodiments, the various referring URLs access the system discretely or, in times of heavy traffic, via a mirror site or the like. Those of skill in the art will appreciate that such approaches and others, whether presently known or future devised, will all fall with the scope of the instant disclosure.

Once in the builder system, buyers follow the intuitive, transformative methods of the invention to begin the process and then modify their selection as they view purchasing, design, price and materials options. In the example illustrated herein, a buyer accesses the system, and encounters an option to select either a quick move-in to an existing home or the purchase of a new home.

Naturally, if a new home already exists and a buyer wishes to accelerate their move-in, there is a tradeoff between the speed of the transaction and various design choices. In other words, while it is possible to consummate a purchasing agreement more quickly in such circumstances (as opposed to building a new home), it is not possible to rotate elevations within a lot, fundamentally redesign the elevation or interior design, etc. In other embodiments, however, buyers are presented with new homes that already exist but have not yet been trimmed, so interior design choices such as color, carpeting, cabinetry, and extras can all be selected within the instant system.

In the event the buyer wishes to build a brand new home, options exist comprising one or more of the selection of a home site (i.e., a lot), a floor plan, architectural add-ons and interior finishes. In other embodiments, still further functionality is realized when surrounding community amenities such as clubhouses, shopping, schools, and professional services can be studied.

In this manner, the buyer is able to combine, modify and select options for their new home in a safe, efficient, and stress-free environment. In various embodiments, selected options are saved and stored under a user profile so that the buyer can leave the system and return to the same choices selected previously.

In a further embodiment, buyers can leave the instant system and open a window to, for example, an associated architectural site to study and compare additional add-ons, and to inform purchasing decisions with respect to third-party vendor options and so on.

Regardless of whether the purchaser is building a new home or buying either a finished or unfinished home that already exists, once the various options are selected they are saved in a secure, reliable user profile so that they cannot be viewed or acted on by third parties.

In another embodiment, once the selections have been made and stored in a user profile summary, the purchaser enters their unique buyer information. In a representative though non-limiting embodiment, such buyer information comprises one or more of the buyer's name (or names in the event of a joint purchase); address; employment information; social security number; and/or authorization for the builder or developer to check the buyer's credit scores and/or credit profile, etc.

Assuming the parties reach agreement—in other words, the buyer has located and selected the desired options and the seller is satisfied that the contours of the commercial arrangement are satisfactory and they are willing to go forward with the buyer-a contract is created for the buyer's review and execution. Currently, most such documents are electronically executed using one of only a few vendors such as DocuSign™ or the like, though many other options are available and will likely be developed in the future.

After the sales contract has been created and executed, an earnest money receiving means such as a user portal, third-party financial receiving means, etc., admits to payment of a deposit that completes the deal insofar as the original purchase is concerned, though those of skill in the art will appreciate that even then it is typically possible for buyers to withdraw from the agreement if they are willing to forfeit their deposit.

At this point, the builder or developer can meet, talk or otherwise communicate with the buyer to discuss the many changes and other issues that inevitably occur in such transactions, such as landscaping, customizations, etc., with confidence that the buyer is already under contract and has deposited earnest money as required.

In other embodiments, the buyer has the option to allow or decline public notice of certain aspects of the transaction such as listings on the builder or developer site, social media, community real estate listings, and so on.

In other embodiments, secure communications between the builder and the buyer are achieved via email, text or other message notification services, whether now known or future devised, so that questions, counteroffers, confirmations, etc., can be communicated.

Ordinarily skilled artisans will appreciate the need for buyer safety and privacy, so appropriate communication protocols and software platforms are used to ensure such measures. For example, FTP (file transfer protocols) and API (application programming interfaces) are commonly used in commerce to safely and securely handle commercial transactions, though many other alternatives either currently in existence or future devised will satisfy with equal efficacy so long as the objects of the invention are borne in mind.

Likewise, countless other industry-specific features can be added to the system and practiced within the scope of the disclosed methodology without departing from the objects of the invention.

In one detailed though non-limiting embodiment, additional features include the ability to add co-buyers and/or real estate agents to the interaction and reporting chains for maximum transparency amongst stakeholders. For example, after a primary buyer has completed a contract application and paid an escrow, a contract creation feature can automatically create a contract and email it to both a co-signer and/or a real estate agent. With this dynamic configuration, pricing transparency and certainty are ensured. For even greater accuracy, the system further comprises one or more payment tools which may further comprise a pre-approval feature, identification authentication and verification, etc.

Finally, a product visualization feature is provided, comprising a plurality of means for organizing and presenting images and information in a manner dictated by user inputs rather than the passive browsing available in nearly all of the other building arts. In addition to presenting floor plans, color combinations and the like, the feature dynamically assists in the process by displaying only combinations of elevations and floor plans that would actually be available to the buyer.

For example, most communities enforce a so-called “monotony rule” in which adjoining lots cannot both have houses with identical elevations built side by side. This rule ensures variety in elevations and design styles throughout the community. In such instances, the system disclosed herein will automatically filter out any such conflicts so that the buyer's time is not wasted and greater product visualization is achieved.

In one embodiment, exclusion system filters such information in both directions. So, if a buyer has decided on a house elevation then only those lots where such a house can actually be built will be presented, and vice versa, so that in instances where the buyer has located a desired lot, the system will only present houses supported by those profiles. In further embodiments, the system similarly filters for available interior features such as color combinations, flooring, room configurations, etc., all rendered live and in response to real-time customer selections, not merely static images stored in a data base.

Though the present invention is disclosed in detail herein with respect to several exemplary embodiments, those of ordinary skill in the art will appreciate that more generally a plurality of minor changes to the description, and various other modifications, omissions and additions may also be made without departing from either the spirit or scope thereof.

1. A computer enabled method for purchasing new construction, said method comprising means for purchasing new construction.

2. The method of claim 1, further comprising means for selecting elevations related to new construction purchasing.

3. The method of claim 1, further comprising means for selecting interior designs related to new construction purchasing.

4. The method of claim 1, further comprising means for selecting purchase contracts related to new construction purchasing.

5. The method of claim 1, further comprising means for selecting earnest money deposit options related to new construction purchasing.
